(19) United States
(12) Patent Application Publication
(10) Pub. No.: US 2026/0057660 A1
(43) Pub. Date: Feb. 26, 2026

(54) System

(71) Applicant: Softbank Group Corp., Tokyo (JP)

(72) Inventor: Ayachika Kitazaki, Tokyo (JP)

(21) Appl. No.: 19/301,378

(22) Filed: Aug. 15, 2025

(30) Foreign Application Priority Data
Aug. 20, 2024 (JP) 2024-138541

(51) Int. Cl. G06V 10/82; G06F 18/15; G06V 10/30; G06V 10/94

(52) U.S. Cl. CPC G06V 10/82; G06F 18/15; G06V 10/30; G06V 10/95

(57) ABSTRACT

A system includes a processor that receives a continuous data stream from a retinal-type sensor, removes noise from the received data stream, normalizes the data from which the noise has been removed, performs image analysis using the normalized data, and transmits an analysis result to a terminal.

### CROSS-REFERENCE TO RELATED APPLICATION

This application is based on and claims priority under 35 USC 119 from Japanese Patent Application No. 2024-138541 filed on Aug. 20, 2024, which is incorporated by reference herein in its entirety.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional image analysis systems, processing is typically performed on a frame-by-frame basis, which limits real-time processing capability and efficiency, particularly when working with continuous data streams from high-speed sensors. Additionally, noise interference from the environment or sensor hardware can decrease data accuracy, and traditional processing methods may not be optimal for deep learning-based image analysis. Furthermore, providing reliable and timely notifications to users based on analytical results is often challenging.

### SUMMARY

To address these issues, the present invention provides a system comprising a processor that receives continuous data streams from a retinal-type sensor, removes noise from the received data, normalizes the cleaned data, performs image analysis using the normalized data, and transmits analysis results to a terminal. The processor can continuously store preprocessed data in a buffer, perform real-time processing, utilize deep learning models for analysis, notify users of analysis results, and communicate wirelessly between the retinal-type sensor and the server, thereby enabling efficient, accurate, and real-time image recognition and notification.

“Retinal-type sensor” means a sensor device designed to imitate or simulate the functionality of the human retina, capable of capturing visual information as continuous data streams.

“Continuous data stream” means a flow of data which is received and processed in real time without being divided into discrete frames, allowing uninterrupted analysis.

“Processor” means a hardware or software component, such as a central processing unit or computational engine, which executes instructions and performs the necessary data processing operations within the system.

“Noise removal” means the process of eliminating or reducing undesirable random or systematic variations within data, originating from environmental interference or sensor artifacts.

“Normalization” means the process of scaling or transforming data into a standard range or format, typically to improve the accuracy or compatibility of subsequent analysis.

“Image analysis” means a process in which received and preprocessed image data is examined using computational techniques, including detection, recognition, and classification of patterns, objects, or behaviors.

“Deep learning model” means a multi-layered neural network trained on large amounts of data for tasks such as object recognition, classification, or feature extraction in images.

“Terminal” means a device, such as a smartphone or computer, which receives results from the processor and presents them to the user through notifications or displays.

“User notification” means the process of informing or alerting a person, by visual, audio, or other signals, regarding the outcome of the image analysis.

“Wireless communication” means data is exchanged between devices, such as the retinal-type sensor and the server, through radio waves or other wireless technologies, instead of wired connections.

“Buffer” means a temporary storage area in memory used to accumulate, hold, or manage data before it is further processed.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

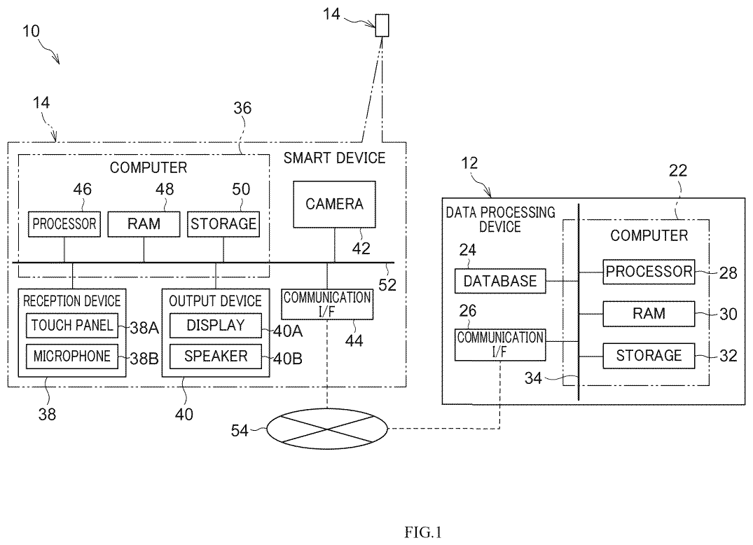

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

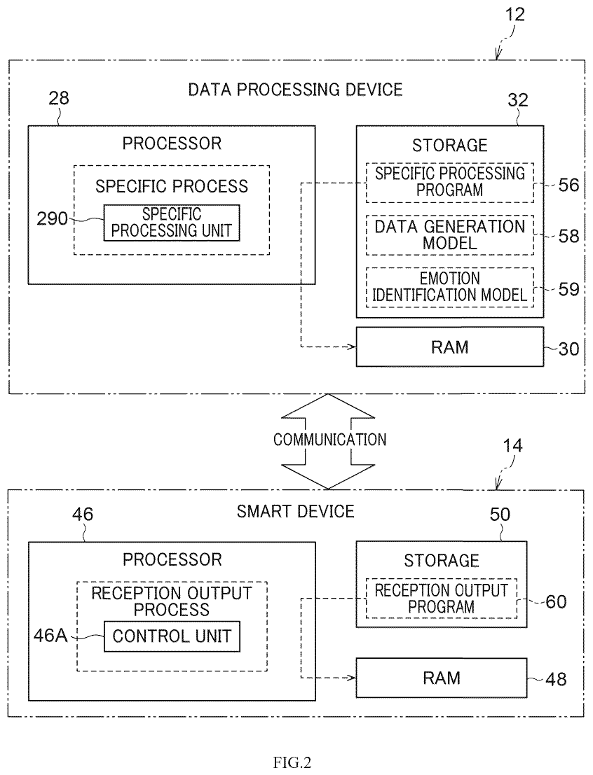

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional image analysis systems processing frame-based data streams often encounter difficulties in achieving real-time, high-precision analysis due to excessive delay and a decrease in accuracy caused by environmental noise and sensor artifacts. Furthermore, existing systems may lack an effective means to rapidly notify users of critical analysis results in a dynamic manner optimized for each situation. There is, therefore, a need for an improved system capable of accurately analyzing continuous biometric optical data in real time, reliably reducing noise, ensuring data normalization, and promptly delivering dynamic notifications to user terminals.

The specific processing by the specific processing unit 290 of the data processing device 12 in Example 1 is realized by the following means.

The present invention provides a server comprising a processor configured to receive a continuous stream of biometric optical data from a biological optical sensor, sequentially store the data, remove noise and unwanted components, normalize the data with regularly updated scaling parameters, analyze the normalized data using a multi-layer machine learning model, and transmit the analysis results to a communication terminal for dynamic user notification. This enables real-time, high-precision analysis of biological optical data, effective noise reduction and normalization, and timely, context-aware notifications to users.

The term “biological optical sensor” refers to a sensor device configured to receive optical information from a biological subject and convert the detected optical signals into corresponding digital data for further processing.

The term “biometric optical data” refers to digital data generated by a biological optical sensor, representing physical or biological characteristics detected using optical means.

The term “temporary storage area” refers to a memory region or storage unit used by the processor to sequentially and temporarily store received data before further processing is performed.

The term “unnecessary components” refers to noise, artifacts, or signal distortions that do not contribute to meaningful analysis and are intended to be removed from the data during preprocessing.

The term “normalized value range” refers to a predetermined range, typically between 0 and 1, to which data values are adjusted to facilitate efficient and accurate analysis by a machine learning model.

The term “multi-layer machine learning model” refers to a computational model consisting of multiple interconnected layers, such as in a neural network, that is trained to perform advanced analysis or classification tasks on input data.

The term “information analysis” refers to the processing of input data by computational means, including feature extraction, classification, detection, or interpretation, to generate meaningful results.

The term “information processing apparatus” refers to a computing device or subsystem that manages the transmission, transformation, or coordination of data between different components of the system.

The term “communication terminal” refers to an electronic device, such as a mobile device or a display-equipped terminal, capable of receiving, displaying, or notifying information to a human user.

The term “dynamic display or notification” refers to the mode in which information or alerts are presented to the user, with the content or format being adjusted in real time based on the nature of the data or the analysis results.

The term “scaling parameters” refers to values, such as maximum and minimum thresholds, that are used to adjust data into a normalized value range.

The term “classification, detection, or anomaly determination” refers to analytical processes that assign input data to predefined categories, identify objects or events within the data, or determine abnormal conditions, respectively, during the analysis stage.

One embodiment of the present invention is implemented as a system comprising a server, a communication terminal, and a biological optical sensor.

The server is equipped with a processor, main memory (RAM), storage, and network interface hardware. The server operates a software program, which may be developed in Python, C++, or equivalent high-level languages, and it may utilize machine learning frameworks such as PyTorch or TensorFlow for information analysis. The server may also utilize data processing libraries such as Pandas and NumPy. The server can be run on general-purpose computing hardware, such as a rack-mounted or cloud-hosted server equipped with CPUs (such as an x86-based processor) and, for performance-intensive tasks like image analysis, GPUs (such as those from a leading manufacturer).

The biological optical sensor refers to a sensor module capable of capturing biometric optical data, for example, a camera module designed to mimic retinal function. This sensor outputs a continuous stream of raw image data or signal data representing biological characteristics.

The server receives a continuous stream of biometric optical data generated by the biological optical sensor. The server sequentially stores the received data in a temporary storage area, such as a RAM buffer. The server periodically executes noise reduction algorithms, such as Wiener filters or deep neural networks, typically implemented using SciPy or TensorFlow, to remove unnecessary components such as background noise, sensor artifacts, and environmental interference. After noise reduction, the server normalizes the data according to scaling parameters, such as minimum and maximum values, which are recalculated at regular intervals to maintain normalization accuracy. This normalization is performed so that the data values reside in a predetermined range (often 0 to 1), which is required by most machine learning models to ensure reliable analysis.

Following preprocessing, the server inputs the normalized data into a multi-layer machine learning model, such as a convolutional neural network (CNN) deployed using a machine learning framework (for example, PyTorch on a GPU). The model performs advanced information analysis, for instance, classification or detection of biometric features. The server then transmits the analysis results to the communication terminal using network protocols such as HTTP or MQTT.

The communication terminal may comprise a general-purpose mobile device, a dedicated notification device, or a computer that is capable of receiving and displaying data sent from the server. The terminal runs dedicated software, which may be developed as a mobile application (e.g., Android or iOS), a web application (using JavaScript), or a desktop application. The terminal receives the analysis results, parses the received data, and presents dynamic notifications or displays to the user based on the analysis context.

The user interacts with the communication terminal, views real-time notifications or alerts, and, if necessary, initiates appropriate actions.

A specific example of use may be described as follows: A biometric optical sensor is installed at an entrance and continuously acquires image data. The server receives and processes this data in real time by removing noise, normalizing the values, and analyzing it with a deep learning model to detect the presence of faces or other specific features. When a detection occurs, the server transmits a notification to a guard's mobile device, which then displays a pop-up alert such as “Face detected at the main entrance at 18:32.” The guard sees this alert and can promptly check the live camera feed or respond according to the security protocol.

An example of a prompt sentence for a generative AI model is as follows:

“Describe the concrete processing flow of a security image analysis system using a retinal-type sensor, server, terminal, and user. Divide the process into steps, and for each step, specify what the server, terminal, or user does, including specific software or hardware used, actual operations, and notification examples.”

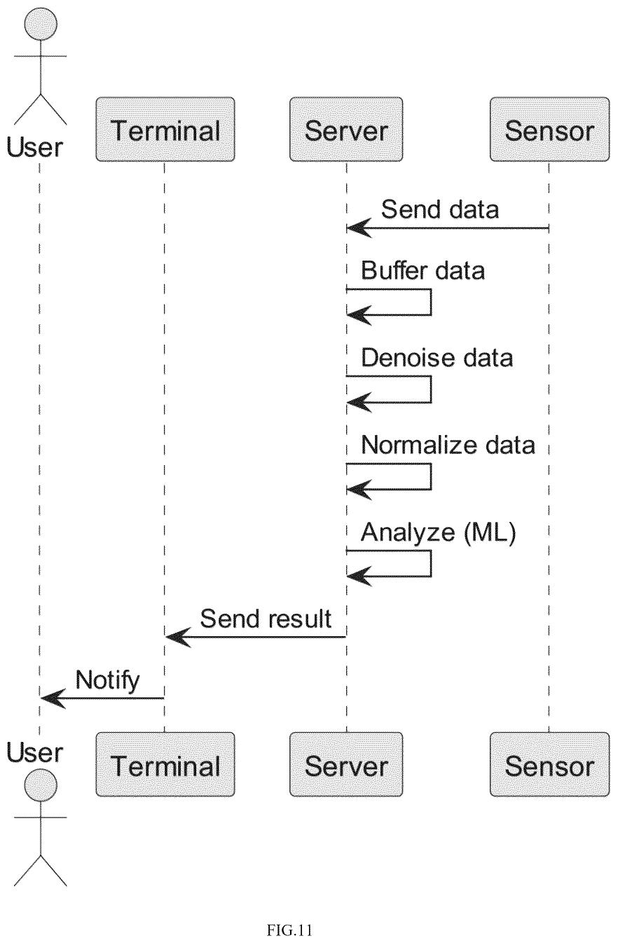

The following describes the processing flow using FIG. 11.

### Step 1:

Server receives a continuous stream of biometric optical data from the biological optical sensor via a wired or wireless network. The input is raw signal or image data output by the sensor in multiple packets per second, typically transmitted using a standard protocol such as TCP/IP. Server stores each received packet in a cyclic RAM buffer along with timestamps for order tracking. The output of this step is a sequence of buffered raw data packets in temporary memory.

### Step 2:

Server processes the buffered raw data by applying noise reduction algorithms. The input is the sequence of raw data packets stored in the buffer. Server executes a denoising filter, such as a Wiener filter or a machine learning-based noise filter implemented with SciPy or TensorFlow, on each packet to remove environmental and sensor-generated noise. Server writes the cleaned data to a separate filter buffer. The output is a set of noise-reduced data frames ready for further processing.

### Step 3:

Server normalizes the noise-reduced data within a fixed value range. The input is the cleaned data extracted from the filter buffer. Server calculates the minimum and maximum values from the data every predefined interval, then rescales each frame to adjust all pixel or signal values into the range 0 to 1 using a min-max scaling function coded in Python or C++. The output is normalized data suitable for input into a machine learning model.

### Step 4:

Server analyzes the normalized data with a multi-layer machine learning model. The input is the normalized data. Server uses a pre-trained deep learning network, such as a convolutional neural network built with PyTorch or TensorFlow, running on a GPU. Server enters the normalized data into the model, which performs feature detection or classification, then outputs analysis results such as object categories, detection locations, and confidence scores. The output is a structured analysis result, such as a JSON object for each processed frame.

### Step 5:

Server transmits the analysis result to the communication terminal. The input is the structured analysis result generated in the previous step. Server sends the result using a protocol like HTTP POST or MQTT to the terminal's software endpoint. The output is that the terminal receives the real-time analysis result data and prepares it for user presentation.

### Step 6:

Terminal processes the received result and notifies the user. The input is the analysis result data received from the server. Terminal parses the data and, based on its content (for example, a face or anomaly detected), dynamically displays a notification on the device screen or sends a push notification. Terminal updates its GUI and stores the notification log if needed. The output is that the user is alerted to important events in real time.

### Step 7:

User reviews the notification and performs an action as needed. The input is the notification or display from the terminal. User checks the message (such as “Face detected at the main entrance at 18:32”) and, depending on the system's purpose, may access a live feed, record a response, or initiate a security protocol. The output is a user-driven action taken in response to the presented analysis.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional real-time monitoring and analysis systems often suffer from insufficient efficiency and accuracy in continuously processing information streams, removing noise, and performing reliable object or behavior recognition. In particular, prompt and accurate detection of suspicious activities, as well as consideration of the user's emotional state, is limited by delays, processing bottlenecks, and lack of integrated user notification mechanisms. Furthermore, typical systems are not equipped to deliver intuitive response proposals or personalized alerts based on real-time analysis results.

The specific processing by the specific processing unit 290 of the data processing device 12 in Application Example 1 is realized by the following means.

The present invention provides a server comprising a processor configured to continuously receive information streams from an information acquisition device, store the streams in a temporary memory, apply image processing to remove unnecessary components, normalize the noise-reduced data, conduct object or behavior recognition using an analysis model including a neural network, identify user emotional states using an emotion estimation model, transmit analysis results to an information terminal device, and provide notifications and response proposals in real time with minimal processing delay. This enables highly efficient, accurate, and user-responsive real-time analysis and notification, integrating both security monitoring and emotion-aware feedback to the user.

The term “processor” refers to an electronic circuit or computing unit capable of executing programmed instructions and performing logical, arithmetic, and control operations necessary for processing information streams and implementing functions of the system.

The term “continuous information acquisition device” refers to a hardware component or sensor, such as an imaging sensor, configured to acquire and output information streams in a continuous, non-interrupted manner.

The term “information stream” refers to a sequence of data elements, such as images, signals, or sensor outputs, transmitted or processed in real time and without interruption.

The term “temporary memory area” refers to a physical or virtual storage location utilized to temporarily store information streams before further processing, such as a buffer or random access memory.

The term “image processing method” refers to computational algorithms or routines executed by the processor to transform, filter, or enhance image data, including but not limited to noise removal and normalization.

The term “unnecessary components” refers to features or data within the information stream that do not contribute to meaningful analysis or recognition, such as environmental noise, artifacts, or sensor errors.

The term “normalization” refers to the process of adjusting and scaling data, especially pixel values, to fall within a predefined and consistent numerical range suitable for analysis models.

The term “information analysis model” refers to a computational framework or algorithm, such as a neural network, designed to analyze the normalized information and perform object recognition, behavior recognition, or emotion estimation.

The term “object recognition” refers to the identification or classification of specific entities, figures, or items present within the processed information stream by computational means.

The term “behavior recognition” refers to the detection or classification of actions, activities, or patterns exhibited within the processed information stream by the use of algorithmic models.

The term “emotion estimation model” refers to a computational model, commonly a neural network, designed to infer the emotional state of a user based on acquired information such as images, sounds, or physiological signals.

The term “recognition information” refers to the output or result generated from object recognition, behavior recognition, or emotion estimation, which can be used for notification or further processing.

The term “information terminal device” refers to an electronic apparatus, such as a mobile device or smart wearable, capable of receiving, displaying, and/or responding to recognition information or notifications from the processor.

The term “notification information” refers to messages, alerts, or data provided to the user via the information terminal device, which communicate the results of analysis and optionally propose user responses.

The term “response proposal” refers to a suggested action, countermeasure, or guidance included within the notification information, formulated according to the outcome of object recognition, behavior recognition, or emotion estimation.

The term “minimal processing delay” refers to the characteristic of performing information reception, analysis, and notification with a reduced or negligible time interval, thereby enabling near real-time responsiveness.

### Embodiment for Implementing the Invention

An embodiment of the invention will be described below, based on the claims and with concrete details, so that one skilled in the art can implement the system accurately and efficiently.

The server constitutes the central processing unit of the system. The server is equipped with a processor, random access memory, permanent storage, an operating system such as Linux, and high-speed networking capabilities. The server also utilizes various software tools and frameworks, including Python as the main programming language, OpenCV for image processing and noise removal, TensorFlow or Keras for implementing information analysis models such as deep neural networks, and Flask for communication with client devices. The server can be implemented on a general-purpose computing apparatus, a data center machine, or a cloud computing platform.

The continuous information acquisition device is typically realized as a sensor capable of capturing continuous data streams. This can include a high-speed machine vision sensor, a specialized retina-type imaging sensor, or another sensor configured to produce real-time, uninterrupted information streams, such as environmental image data or video streams.

The server receives the information stream from the acquisition device via a designated communication method, which may be wireless or wired, and stores the data temporarily in a memory buffer. The server applies image processing techniques using OpenCV to remove unnecessary components, including random noise, sensor artifacts, or environmental disturbances. When necessary, the server performs grayscale conversion or contrast adjustments to improve the clarity and quality of the data for subsequent analysis.

After preprocessing, the server normalizes the data, adjusting pixel or feature values into a predefined range, typically between 0 and 1, leveraging available Python and NumPy functions. The normalized information is then analyzed by a neural-network-based information analysis model, which is implemented with TensorFlow or Keras. This model is trained to perform object recognition or behavior recognition. In some cases, the server may also execute an emotion estimation model to infer the emotional state of the user, analyzing information such as facial images extracted from the data stream.

The analysis results, such as object recognition output, detected behavior, or estimated emotion, are packaged and transmitted from the server to an information terminal device. The information terminal device may include a mobile communication device, wearable apparatus such as smart glasses, or another user-facing appliance equipped with a processor and display. The terminal receives the notification from the server through a network protocol such as HTTP or WebSocket, using Flask or similar communication frameworks.

The terminal processes the received recognition information and notification, and presents it to the user in a manner suitable for the specific use situation. The notification may include alerts such as the detection of a suspicious object, identification of certain behaviors, or guidance corresponding to an estimated emotional state. The terminal may employ methods such as text display, audio notification, or haptic feedback to communicate relevant information to the user. The user, upon receiving such notification, can take appropriate responsive actions such as investigating a location, escalating a security protocol, or adjusting their own behavior.

A concrete example includes the use of a retina-type imaging sensor mounted in smart glasses, which continuously transmits image data to the server. The server processes the data with OpenCV for noise removal and normalization, then applies TensorFlow models for detecting suspicious persons. Upon detection, the server immediately notifies a user's mobile device or the smart glasses, whereupon the device informs the user in real time, allowing rapid evaluation and security response.

The system can also be applied to non-security use cases, such as online education. In such an embodiment, the server analyzes video or audio data for emotional cues using the emotion estimation model, and teachers can be alerted if students show confusion or other emotions, enabling them to adapt their teaching methods in real time.

An example prompt sentence for implementation using generative AI models is as follows:

“Implement a real-time monitoring system that continuously acquires image data using a retina-type imaging sensor, processes and normalizes the data with Python and OpenCV, analyzes the images using a TensorFlow deep learning model for object detection, and communicates analysis results in real time to a mobile device or wearable terminal. Provide the user with immediate notifications related to detected objects, behaviors, or emotional states.”

With this embodiment, those skilled in the art can realize the invention, leveraging general-purpose server hardware, mainstream sensors, and well-established open-source software frameworks. The system's hardware and software components are readily configurable, providing high efficiency, low delay, and substantial versatility for a wide range of application domains.

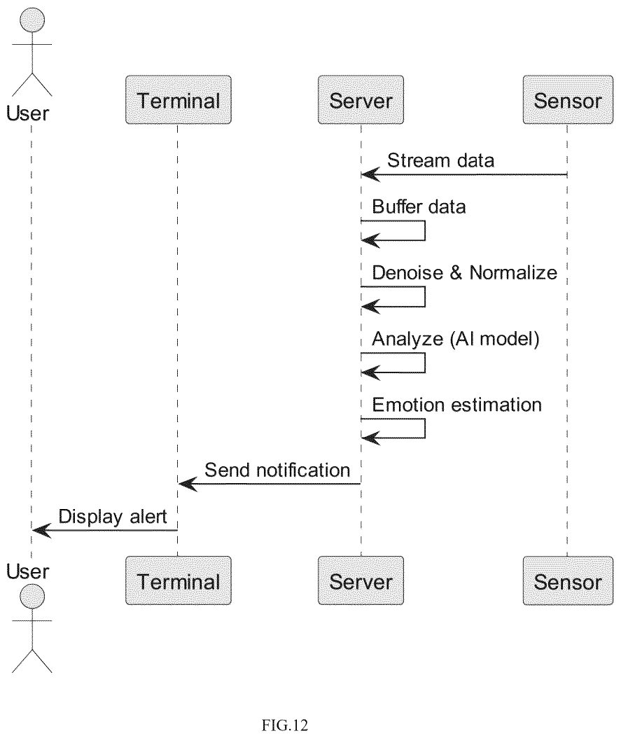

The following describes the processing flow using FIG. 12.

### Step 1:

The server receives a continuous information stream from a continuous information acquisition device.

The input for this step is raw information data, such as image or sensor signals, transmitted in real time from the acquisition device.

The server establishes a network connection (for example, using TCP/IP or WebSocket) and collects the streaming data continuously.

The output of this step is the raw information stream, which is passed to the next step.

### Step 2:

The server stores the received information stream in a temporary memory area.

The input is the raw information stream from Step 1.

The server utilizes a buffer or memory array to retain a specified length of the data stream, allowing stable processing and later retrieval.

The output is buffered data held in memory, ready for preprocessing.

### Step 3:

The server applies an image processing method to the buffered data in order to remove unnecessary components.

The input is the temporary buffered image or sensor data from Step 2.

The server uses an image processing library (such as OpenCV) to apply noise reduction techniques like Gaussian blurring or denoising filters, as well as optional grayscale conversion, discarding environmental noise and irrelevant data.

The output is cleaned, noise-reduced information.

### Step 4:

The server normalizes the cleaned data within a defined numerical range.

The input is noise-reduced information from Step 3.

The server calculates the minimum and maximum values in the dataset or each image, then scales all pixel values to a range from 0 to 1.

The output is normalized data formatted for input into analysis models.

### Step 5:

The server conducts object recognition or behavior recognition using an information analysis model.

The input is the normalized data from Step 4.

The server loads a pre-trained neural network model (using a software framework such as TensorFlow or Keras) and performs inference on the normalized data, generating recognition results such as object type, suspicious activity, or location information.

The output is recognition information generated as analysis results.

### Step 6:

The server optionally executes emotion estimation using an emotion estimation model.

The input is either the original or preprocessed information data, such as images focused on a user's face or audio data.

The server applies the emotion estimation model (for example, a deep neural network trained for emotion classification) and derives a categorical or probabilistic emotion label.

The output is the inferred emotional state of the user.

### Step 7:

The server creates notification information by packaging recognition information and emotion estimation results, then transmits this data to the information terminal device.

The input is the recognition information and the emotion estimation result from previous steps.

The server organizes these results in a structured format (such as JSON) and sends them to the information terminal device using a network communication protocol (for example, via HTTP POST request or WebSocket message).

The output is notification information that arrives at the information terminal device.

### Step 8:

The terminal receives notification information and displays it to the user.

The input is the notification information sent from the server.

The terminal parses the received data, then renders or presents the notification using visual cues (such as alerts or banners), audio prompts, or vibration feedback, depending on the terminal's hardware.

The output is real-time user awareness of the recognition results and suggested response.

### Step 9:

The user reviews the notification and may take further action.

The input is the notification as presented on the terminal.

The user interprets the display and, according to the provided information and any included response proposal, decides on and executes a next action, such as investigating a specific area, communicating with others, or modifying their own behavior.

The output is the user's selected response to the notification.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventionally, it has been difficult to accurately and efficiently process and analyze continuous streams of raw biometric information, such as image or physiological data, in real time due to the presence of significant noise and variability in the data. Existing systems often struggle to extract meaningful features, perform high-precision classification, and provide timely feedback to users, especially when auxiliary sensor information must also be considered. Thus, there has been a need for a system capable of integrated real-time data acquisition, noise removal, normalization, deep feature extraction and identification, behavioral state estimation, and efficient user notification.

The specific processing by the specific processing unit 290 of the data processing device 12 in Example 2 is realized by the following means.

The present invention provides a server comprising a processor configured to receive continuous biometric information, remove unnecessary components, normalize such information, store the information temporarily, perform feature extraction and identification by using a multilayered learning model, estimate a behavioral state based on both identification results and auxiliary information, transmit these results to an information processing device, and cause said device to provide user notification. This enables accurate, real-time processing of biometric information and auxiliary data, high-precision classification and behavioral estimation, and prompt delivery of relevant information to users.

The term “biometric information acquisition device” refers to a hardware device configured to capture and transmit biological or physiological data from a subject, such as image data, physiological signals, or other sensor-based measurements.

The term “unnecessary components” refers to signal elements, noise, or artifacts present in the raw biometric information that are irrelevant or detrimental to accurate data analysis or feature extraction.

The term “normalize” refers to the process of adjusting the range or distribution of biometric data values so that they fall within a predetermined, typically standardized, range.

The term “temporary storage region” refers to a section of a memory device used to temporarily hold processed or intermediate data for subsequent computational stages.

The term “multilayered learning model” refers to a machine learning or artificial intelligence model comprising multiple processing layers, such as neural networks, capable of extracting features and performing classification or identification tasks.

The term “feature extraction and identification” refers to the computational process of analyzing data to derive meaningful attributes or patterns and subsequently determining the category, identity, or classification of the input based on those attributes.

The term “auxiliary information” refers to additional data acquired from supplementary sensors or input sources that are used to enhance the analysis and estimation of the behavioral state.

The term “estimate a behavioral state” refers to the computational determination or inference of a user's physical, psychological, or emotional condition by analyzing biometric and auxiliary information.

The term “information processing device” refers to any device, such as a computer, smartphone, or tablet, capable of receiving, processing, and displaying or transmitting data.

The term “user notification” refers to the process by which information, results, or alerts are communicated or presented to an end user, typically via a display, audio signal, or other interface.

In order to practice the present invention, a system equipped with a server, a biometric information acquisition device, and a terminal may be employed. The biometric information acquisition device may include, for example, an optical sensor, camera, or physiological sensor, which can continuously capture biological information such as images or physiological signals from a subject. The server is connected to the biometric information acquisition device through a wired or wireless network, and is responsible for receiving, processing, and analyzing the data in real time.

The server typically comprises a processor, working memory, non-volatile memory, and network interface. In one embodiment, the server may use general-purpose computing hardware such as an x86 architecture processor with RAM, and may further include a graphics processing unit (GPU) for acceleration of machine learning models. The biometric information is received by the server through a data transmission protocol such as TCP/IP or a wireless protocol. The server stores the received data in a buffer or temporary storage region implemented in system memory.

During operation, the server executes software components including data cleaning modules, a normalization module, and a feature extraction and identification module that utilizes a multilayered learning model. Commercially available software libraries, such as SciPy for noise filtering, NumPy for normalization, and deep learning frameworks such as TensorFlow or PyTorch for machine learning, may be employed on the server. The server may also contain a behavioral state estimation module that determines the behavioral or emotional state of the user by analyzing both primary biometric information and auxiliary information collected from supplementary sensors (e.g., microphones or accelerometers).

The results of the estimation and identification processes are formatted and transmitted from the server to a terminal device, such as a smartphone or a tablet, using standardized communication protocols such as HTTP or WebSocket. The terminal, implemented as a software application running on a mobile operating system, is configured to receive the transmitted results and notify the user through display, sound, or vibration.

As a concrete example, a user may wear a wearable camera as the biometric information acquisition device, which streams image data to a server equipped with a GPU. The server applies a noise filter to the data using SciPy, normalizes the image using NumPy, and processes the data using a neural network implemented in PyTorch to classify the detected objects or recognize facial attributes. An emotion recognition engine may further utilize an LSTM-based model implemented in TensorFlow to estimate emotional states. The server then sends a notification to the user's smartphone, which displays a message such as “Face detected, emotion: joy.”

An example prompt sentence for a generative AI model in the context of this system could be:

“Please explain in detail the mechanism by which a system receives continuous data from a biometric information acquisition device and performs real-time noise filtering, data normalization, image analysis, and behavioral state estimation, including how the result is notified to the user.”

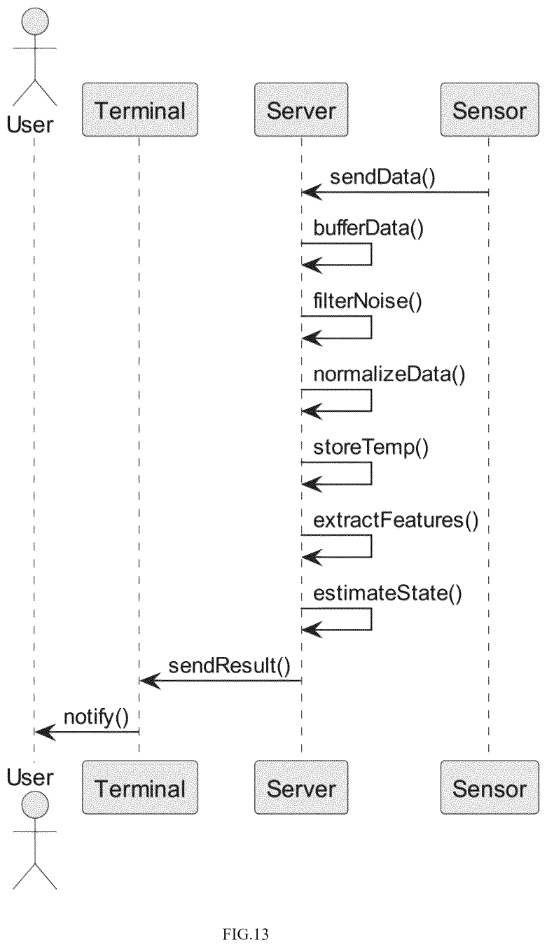

The following describes the processing flow using FIG. 13.

### Step 1:

The server receives continuous raw biometric data from the biometric information acquisition device.

Input: Raw signals or images from the biometric information acquisition device.

Processing: The server collects this data, typically using socket communication or HTTP protocols, and writes it into a temporary buffer in its memory to ensure no data is lost before processing.

Output: Raw biometric data stored in the server buffer.

Concrete action: The server allocates buffer space in RAM and verifies data arrival intervals to maintain seamless data acquisition.

### Step 2:

The server removes unnecessary components (noise) from the buffered biometric data.

Input: Raw biometric data from the buffer.

Processing: The server applies a noise filtering algorithm, such as a digital low-pass filter implemented via a scientific computing library, to eliminate high-frequency noise or artifacts from the data.

Output: Denoised biometric data.

Concrete action: The server uses software tools like SciPy to process each data frame and verify that noise levels are within an acceptable threshold.

### Step 3:

The server normalizes the denoised biometric data to a predetermined range.

Input: Denoised biometric data.

Processing: The server computes the minimum and maximum values in the data and rescales all values so that they fall within a standardized range, such as 0 to 1, using normalization algorithms.

Output: Normalized biometric data.

Concrete action: The server utilizes a data processing library such as NumPy to conduct normalization and ensure uniformity across all processed data.

### Step 4:

The server stores the normalized biometric data in a temporary storage region for further analysis.

Input: Normalized biometric data.

Processing: The server writes each processed data segment into a designated area in the working memory for access by analytical modules.

Output: Normalized data stored in temporary memory.

Concrete action: The server maintains an organized queue or database table to allow sequential access by downstream processing modules.

### Step 5:

The server performs feature extraction and identification using a multilayered learning model.

Input: Normalized biometric data stored in temporary memory.

Processing: The server inputs the data into a multilayered neural network model, implemented using frameworks such as TensorFlow or PyTorch, to extract features and identify patterns or objects.

Output: Feature extraction and identification results (e.g., object type, facial attributes).

Concrete action: The server loads the pre-trained neural network model onto a GPU and executes inference to generate identification results in real time.

### Step 6:

The server estimates a behavioral state based on identification results and auxiliary information.

Input: Feature extraction/identification results and additional auxiliary sensor data.

Processing: The server combines the primary identification results with supplementary information (such as audio or movement data) and uses a behavioral state estimation algorithm, such as an LSTM network, to infer the user's current state.

Output: Estimated behavioral state.

Concrete action: The server synchronizes time-stamped auxiliary sensor inputs and runs the behavioral estimation module to output a state such as “happy” or “active.”

### Step 7:

The server transmits the identification results and the estimated behavioral state to the terminal.

Input: Identification results and estimated behavioral state.

Processing: The server formats the results into a structured data format, such as JSON, and sends them to the terminal over a network connection.

Output: Structured results received by the terminal.

Concrete action: The server establishes a secure client-server communication channel and confirms data delivery to the terminal.

### Step 8:

The terminal notifies the user of the received results.

Input: Structured results from the server.

Processing: The terminal parses the results and displays a notification, message, or alert to communicate the detected information and estimated user state.

Output: Notification presented to the user.

Concrete action: The terminal generates a popup message or notification on the user's device, such as “Face detected, emotion: joy.”

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional systems for monitoring workers in environments such as factories, it has been difficult to continuously and accurately assess the emotional state and degree of fatigue of users in real time. Existing solutions do not provide adequate feedback to users based on their current status, thereby making it challenging to ensure safety, prevent overwork, and improve work efficiency. There is a need for a system that can automatically recognize user states from sensor data and provide appropriate instructions or notifications in a timely manner.

The specific processing by the specific processing unit 290 of the data processing device 12 in Application Example 2 is realized by the following means.

The present invention provides a server comprising a processor configured to receive a continuous set of information from an information acquisition device, remove unnecessary components from the received information, normalize the information, perform feature extraction and discrimination processing using a learning model, transmit the results to a terminal device, and cause the terminal device to present information to the user based on the results. This enables the real-time and automated recognition of a user's emotional and fatigue states, and allows for timely feedback and instructions to be provided to the user, thereby improving safety and operational efficiency.

The term “information acquisition device” refers to a general hardware component or apparatus configured to collect and transmit data, such as a sensor or camera, that captures information related to the user or environment.

The term “continuous set of information” refers to a stream of data that is received without interruption over a period of time, comprising multiple data points or frames captured sequentially.

The term “unnecessary components” refers to elements within the acquired data that have no relevance to the analysis or could degrade the accuracy of subsequent processing, such as noise or artifacts.

The term “normalize” refers to the process of scaling or converting data into a common range or format suitable for further computational processing.

The term “feature extraction processing” refers to a computational operation that identifies and isolates relevant characteristics or patterns within the normalized data for the purpose of further analysis.

The term “discrimination processing” refers to a decision-making computation that classifies or estimates a particular condition or state from the extracted features.

The term “learning model” refers to a computational or mathematical model, often based on machine learning or artificial intelligence techniques, trained to recognize patterns or predict states from processed data.

The term “terminal device” refers to any general computing device or apparatus capable of receiving processed information from the server and presenting it to a user, such as a display-equipped wearable device or a mobile terminal.

The term “information presentation processing” refers to the act of conveying analysis results or notifications to the user through the terminal device, typically in a visible or audible form.

The term “temporary storage device” refers to a memory resource or storage system that holds data temporarily during intermediate stages of processing.

One embodiment for implementing the invention is described below.

The system comprises a server equipped with a processor, an information acquisition device such as an image sensor, and a terminal device such as a wearable smart display. The server operates in communication with the information acquisition device and the terminal device via a communication network, which may be wireless or wired.

The server is implemented as a general-purpose computing device or cloud-based computational resource. The information acquisition device is attached to the user, for example, as part of smart glasses or a wearable camera, and captures image data of the user's face and surrounding environment continuously.

The server operates specialized software built using frameworks such as TensorFlow or Keras for machine learning, and OpenCV for image processing. The terminal device, for example a wearable smart display, is capable of receiving output data from the server and presenting it visually or audibly to the user.

The server receives a continuous stream of image or sensor data from the information acquisition device. The server performs a data cleaning step, removing unnecessary components such as noise or irrelevant background elements using image processing libraries. The cleaned data is then normalized, for instance, by scaling pixel values between zero and one using numerical computation libraries such as NumPy.

Next, the server applies a feature extraction process using a pre-trained learning model, which is implemented using machine learning frameworks. The server discriminates the user's state, such as emotion or fatigue level, by applying the inference capability of the learning model to the extracted features.

After obtaining the result, the server transmits the analysis and recommendations to the terminal device by means of a REST API, which may be implemented using web frameworks such as Flask. The terminal device receives this data and presents information to the user, such as a message on the display indicating to take a break if fatigue is recognized.

This system enables real-time and automated monitoring of the user's emotional and physical states, and provides timely feedback to the user, thereby improving safety and operational efficiency in workplace environments.

As an example, when a user is engaged in monotonous or stressful tasks for an extended period, the information acquisition device captures a neutral or fatigued expression of the user. The server analyzes the data stream, determines the presence of fatigue, and the terminal device displays a message such as “Please take a break” to the user.

An exemplary prompt sentence for requesting generation of a software implementation by a generative AI model is as follows:

“Write a Python program using OpenCV and TensorFlow that continuously analyzes a worker's facial expressions from camera input. If the server detects that the worker remains expressionless for over five minutes, automatically send a ‘Take a Break’ notification to display on the worker's smart glasses using a REST API interface.”

This embodiment provides a detailed reference so that others can understand and practically implement the invention according to the disclosed claims.

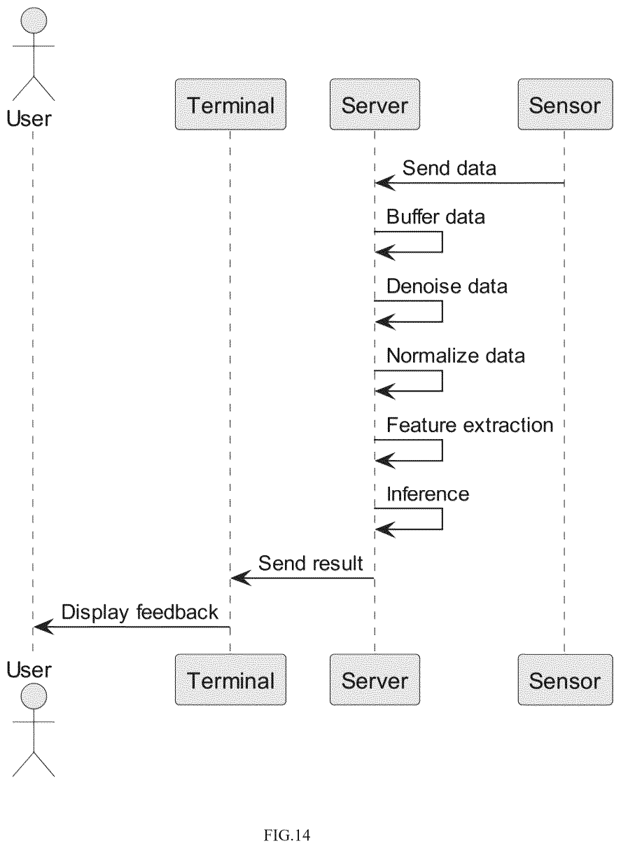

The following describes the processing flow using FIG. 14.

### Step 1:

Server receives a continuous data stream from the information acquisition device attached to the user. The input is the raw image data or sensor data transmitted in real time from the sensor. The server ingests these data packets as they arrive via network communication. The output is the storage of this incoming data stream in a memory buffer for further processing.

### Step 2:

Server stores the received raw data sequentially in a buffer. The input is the real-time raw data received from the sensor. The server appends each new frame or data point to the buffer while managing memory to keep the latest set of information for analysis. The output is a rolling set of buffered data, ready for preprocessing.

### Step 3:

Server removes unnecessary components such as noise from the buffered data. The input is the buffered raw data containing possible noise and unwanted artifacts. The server applies digital filtering and denoising techniques using software such as OpenCV to clean the data. The output is a denoised and cleaner version of the data.

### Step 4:

Server normalizes the denoised data for further computational processing. The input is the cleaned data output from the denoising step. The server scales the pixel values or signal values into a defined range (such as 0 to 1) using normalization routines provided by computation libraries like NumPy. The output is normalized data that is suitable for input to a machine learning model.

### Step 5:

Server performs feature extraction using the normalized data. The input is the normalized image or sensor data. The server utilizes pre-trained machine learning models to extract relevant features such as facial landmarks, eye openness, or other biometric indicators. The output is a set of extracted features which succinctly represent the state of the user.

### Step 6:

Server performs discrimination processing or inference using a learning model. The input is the extracted features from the previous step. The server applies a trained deep learning model, for example using TensorFlow or Keras, to classify or estimate the user's state, such as emotion or fatigue level. The output is an identified state label or a numerical score representing the user's current condition.

### Step 7:

Server transmits the inference result to the terminal device. The input is the state or score indicating user emotion or fatigue estimated by the model. The server formats this information in a suitable data structure (such as JSON) and sends it via a REST API to the terminal device. The output is the successful delivery of the analyzed result to the terminal device.

### Step 8:

Terminal receives and displays the feedback to the user. The input is the analysis result received from the server. The terminal interprets the result and presents an appropriate message or alert on the user's interface, such as displaying “Please take a break” on smart glasses. The output is the visible or audible presentation of the feedback to the user.

### Step 9:

User recognizes and acts on the feedback provided by the terminal. The input is the notification or instruction displayed on the terminal device. The user processes this information and may perform actions such as pausing operations or taking a rest. The output is the user's behavioral response, completing the feedback loop initiated by the system.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

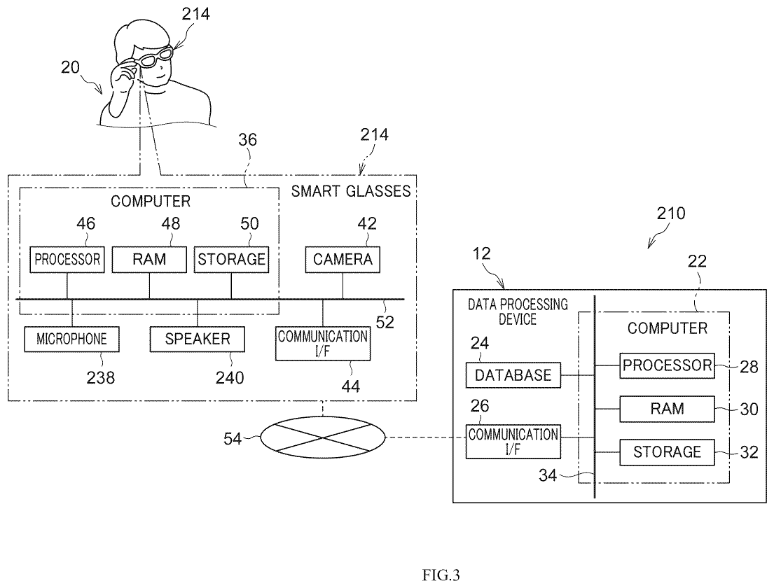

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

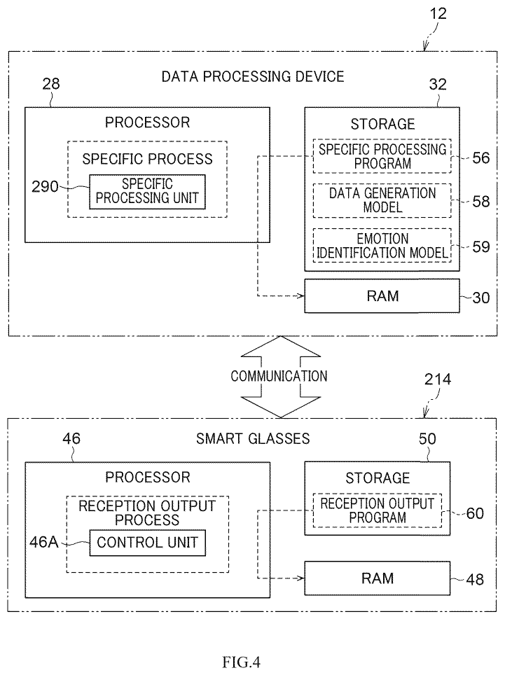

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

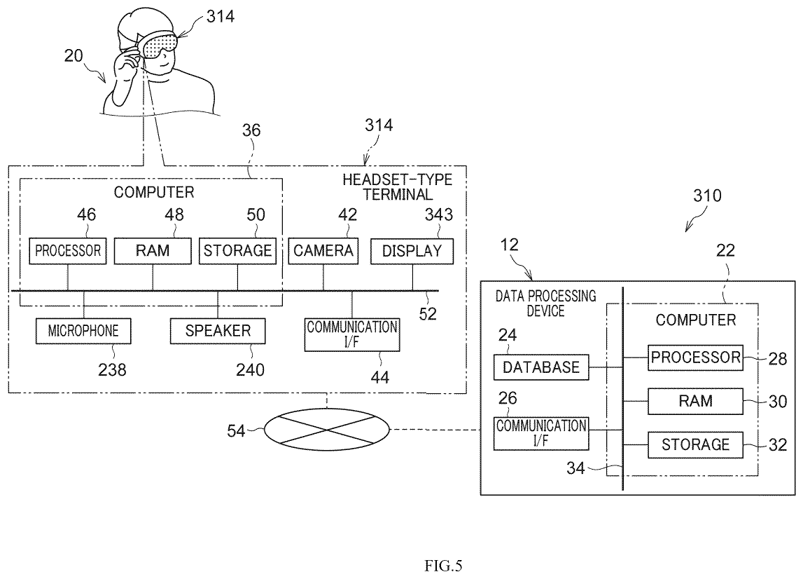

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

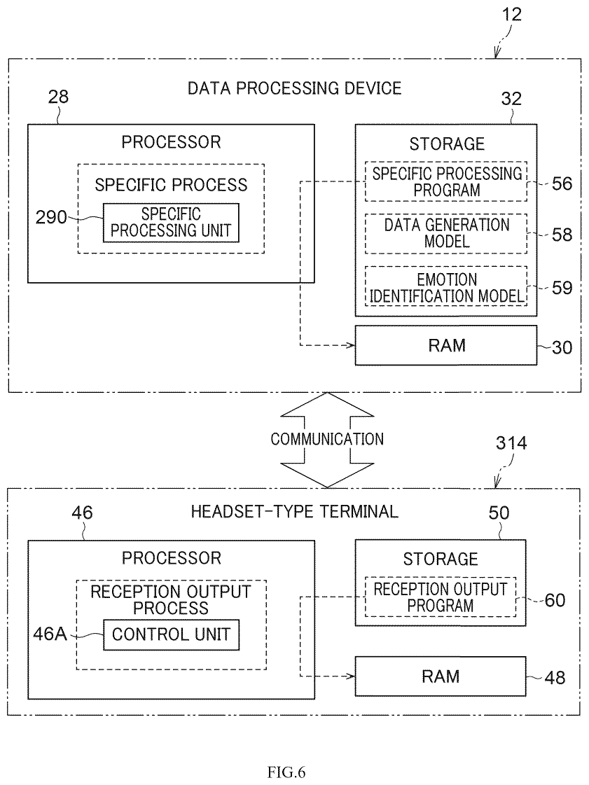

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

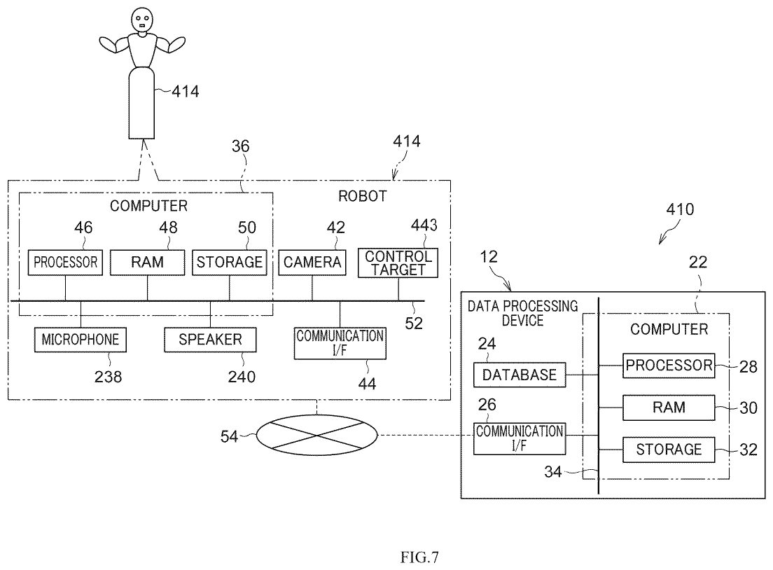

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

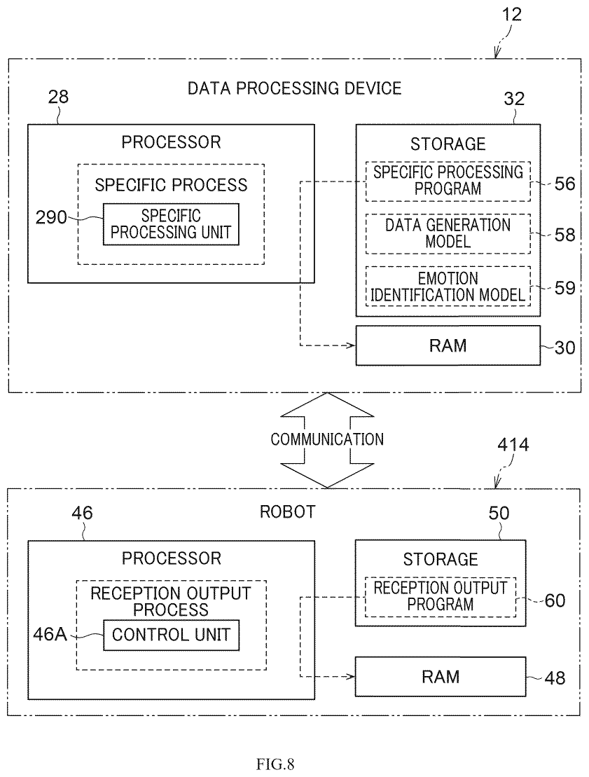

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

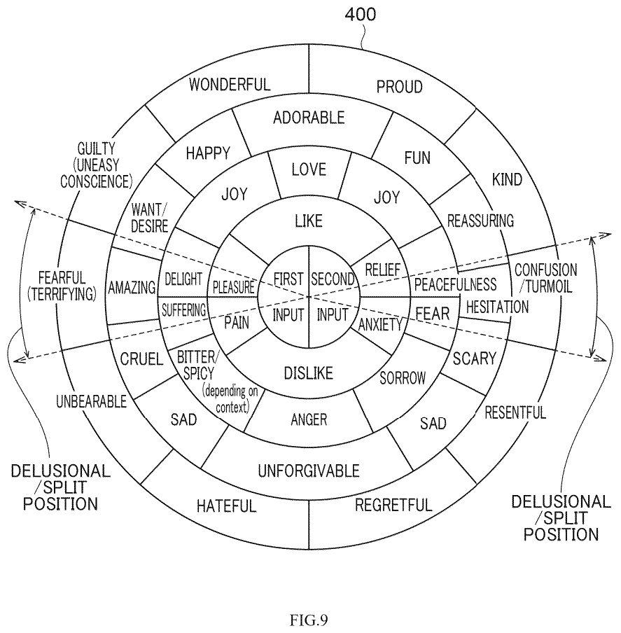

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

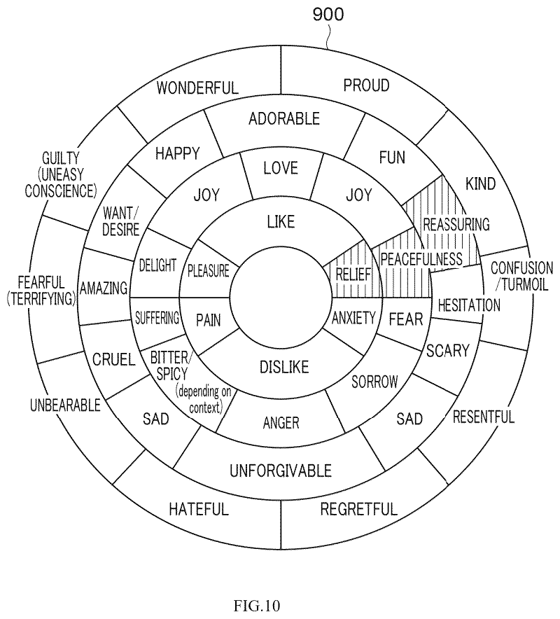

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive a continuous stream of biometric optical data from a biological optical sensor,
sequentially store the received data in a temporary storage area,
remove unnecessary components from the stored data,
transform the data, from which unnecessary components have been removed, into a normalized value range,
input the normalized data into a multi-layer machine learning model to perform information analysis,
transmit the analysis result, via an information processing apparatus, to a communication terminal, and
cause the communication terminal to dynamically display or notify information to a user based on the received analysis result.

### (Supplementary 2)

The system according to supplementary 1,
wherein the processor is configured to
determine a maximum value and a minimum value for normalization at a predetermined cycle, based on the data stored in the temporary storage area, to maintain normalization accuracy.

### (Supplementary 3)

The system according to supplementary 1,
wherein the processor is configured to
perform classification, detection, or anomaly determination based on the analysis result for each data group processed by the multi-layer machine learning model, and to switch notification information according to the content of the analysis result.

### Application Example 1

### (Supplementary 1)

A system comprising a processor,
wherein the processor is configured to
receive a continuous information stream from a continuous information acquisition device,
store the received information stream in a temporary memory area,
apply an image processing method to the information acquired from the temporary memory area in order to remove unnecessary components,
normalize the information from which unnecessary components have been removed within a defined range,
execute object recognition or behavior recognition on the normalized information using an information analysis model,
transmit recognition information generated as a result of the analysis to an information terminal device,
display notification information to a user on the basis of the recognition information received by the information terminal device,
identify an emotional state of the user by utilizing an emotion estimation model during or after the analysis process, and transmit the result of the identification together with the notification information,
and process the sequence from information stream reception to notification with reduced processing delay in a continual manner.

### (Supplementary 2)

The system according to supplementary 1,
wherein the processor is configured to
employ an analysis processing unit including a neural network as the information analysis model and the emotion estimation model.

### (Supplementary 3)

The system according to supplementary 1,
wherein the processor is configured to
present a response proposal in the notification information to the information terminal device, said response proposal corresponding to the specific object recognition, behavior recognition, or identified emotional state.

### Example 2

### (Supplementary 1)

A system comprising a processor,
wherein the processor is configured to
receive continuous data from a biometric information acquisition device,
remove unnecessary components from the received biometric information,
normalize the biometric information after removal to a predetermined range,
store the normalized biometric information in a temporary storage region of a memory device,
perform feature extraction and identification using a multilayered learning model with respect to the biometric information stored in the temporary storage region,
estimate a behavioral state based on the feature extraction and identification results and additionally acquired auxiliary information,
transmit the estimated behavioral state and identification results to an information processing device, and
cause the information processing device to notify a user of the transmitted results.

### (Supplementary 2)

The system according to supplementary 1,
wherein the processor is configured to
execute processing of the biometric information and auxiliary information sequentially and in chronological order, so as to realize real-time state estimation processing.

### (Supplementary 3)

The system according to supplementary 1,
wherein the processor is configured to
execute the multilayered learning model in a high-speed estimation environment utilizing computational resources of a computing device, and transmit the computation results to an external device using a standardized communication method.

### Application Example 2

### (Supplementary 1)

A system comprising a processor,
wherein the processor is configured to
receive a continuous set of information from an information acquisition device,
remove unnecessary components from the received set of information,
normalize the set of information from which unnecessary components have been removed,
perform feature extraction processing using the normalized set of information,
perform discrimination processing on the result of the feature extraction processing,
transmit the result of the discrimination processing to a terminal device,
cause the terminal device to perform information presentation processing based on the result of the discrimination processing,
and automatically and continuously execute the information extraction processing and discrimination processing to provide instruction information in real time according to the state of a user.

### (Supplementary 2)

The system according to supplementary 1,
wherein the processor is configured to sequentially store the received set of information in a temporary storage device.

### (Supplementary 3)

The system according to supplementary 1,
wherein the processor is configured to perform inference using a learning model as the feature extraction processing and the discrimination processing.

What is claimed is:

1. A system comprising a processor that is configured to:
receive a continuous data stream from a retinal-type sensor;
remove noise from the received data stream;
normalize the data from which the noise has been removed;
perform image analysis using the normalized data;
and transmit an analysis result to a terminal.

2. The system according to claim 1, wherein the processor continuously stores preprocessed data in a buffer.

3. The system according to claim 1, wherein the processor processes the received data stream in real time.

4. The system according to claim 1, wherein the processor performs image analysis using a deep learning model.

5. The system according to claim 1, wherein the processor notifies a user of the analysis result.

6. The system according to claim 1, wherein the communication between the retinal-type sensor and a server is performed wirelessly.
